(19) United States
(12) Patent Application Publication
(10) Pub. No.: US 2023/0286193 A1
(43) Pub. Date: Sep. 14, 2023

(54) A CUTTING GUIDE

(71) Applicants: Mark THOMPSON, Orpington Kent (GB); James Alexander WIGAN, Wrotham Kent (GB)

(72) Inventors: Mark THOMPSON, Orpington Kent (GB); James Alexander WIGAN, Wrotham Kent (GB)

(21) Appl. No.: 18/019,012

(22) PCT Filed: Jul. 14, 2021
(86) PCT No.: PCT/IB2021/056336

§ 371 Date: Jan. 31, 2023

(30) Foreign Application Priority Data
Aug. 3, 2020 (GB) 2012027.5

(51) Int. Cl. B28D 7/04; B24B 23/02

(52) U.S. Cl. CPC B28D 7/04; B24B 23/028; B28D 1/04

(57) ABSTRACT

A cutting guide comprising: a substantially planar plate with a lip arranged to extend orthogonally from the plate along at least one edge of the plate. Two or more slots are provided to guide a cutting blade. An entrance to at least one of the slots on an outer face of the lip tapers to guide the cutting blade into the slot and wherein a portion of an inner face of the lip that corresponds to the slot is shaped to define a corner in which material to be cut is positioned.

### FIELD OF THE INVENTION

The present invention relates to a cutting guide, in particular a cutting guide for providing a platform for an object such as a block, during cutting; more particularly but not exclusively for cutting with a tool such as for angle grinding.

### BACKGROUND

Using machinery in construction and landscaping allows greater ranges of materials to be used commonly. In paving or general construction greater varieties of blocks of pavers can be utilised as construction workers or builders are enabled to easily cut 15 them with angle grinders or other rotary saw tools.

When using such tools the builders often put a foot on block to hold it in place as it is cut. This can be dangerous, leading to kickbacks, slippage, or other chances of damage to the block, tool or user.

The present invention arose in order to overcome problems suffered by existing devices.

### PRIOR ART

GB2573130 (JONES) discloses a brick cutting safety tool comprising a substantially planar base member having a support brace receptacle extending therefrom.

US 2012 0 227 726 (HIGGINS) discloses a corner jig fora masonry saw for fabricating a cut in a masonry unit (e.g., brick) such as to form a corner brick veneer may have a push block wherein its height is substantially equal to a length of a brick to be formed into the corner brick veneer.

U.S. Pat. No. 7,669,841 (KRASOWSKI) discloses a support brace includes a bottom section that 35 has planar top and bottom surfaces.

### SUMMARY OF THE INVENTION

According to the present invention there is provided a cutting guide comprising: a substantially planar plate with a lip arranged to extend orthogonally from the plate along at least one edge of the plate; a plurality of slots is formed in the plate and extend through the lip for guiding a cutting blade; wherein an entrance to at least one of the slots on an outer face of the lip tapers to guide the cutting blade into the slot; and wherein a portion of an inner face of the lip is shaped to define a notch in which material to be cut is positioned.

In this way a user can cut or score materials such as blocks by placing them upon an upper surface of the plate, positioning the item to be cut or scored against part of the lip and over one of the slots and passing a cutting blade through the slot and thereby cutting or scoring the item. Advantageously the cutting guide enables precise cuts or scoring to be made safely and allows for clearance of the cutting blade.

Furthermore when the guide is used with a circular cutting blade the rotation of the cutting blade acts to pull the item to be cut against the lip. This ensures improved safety by holding the item to be cut against the lip so that it is not liable to move during cutting.

The upper surface of the planar plate receives items to be cut. In some embodiments the upper surface of the guide has a raised and lowered surface, for example with a textured surface that is adapted to increase friction against a block. In this way items to be cut are less liable to slip during cutting. Advantageously the raised and lowered surface may also prevent kickback of the tool that is a common issue when cutting blocks with tools such as angle grinders as the raised and lowered surface of the cutting guide provides a rough surface which creates additional friction when a brick or block is placed upon the cutting guide. The two rough surface and object to be cut rub together which increases the levels of friction thus preventing sliding and/or kickback.

A lower surface of the planar plate may include the securing means such as having a raised and lowered surface so as to engage with and grip with the ground.

For example in some embodiments the lower surface comprises a plurality of barbs adapted to stick into the ground. The barbs may be envisaged to comprise points or may be envisaged to narrow away from the top face so as to pierce the ground. In this way it may be envisaged that when the cutting guide is in use on soil or grass or similar the securing means such as the barbs may be envisaged to insert into the ground under downward pressure of weight.

The lower surface is designed to avoid slipping in use, and in this way advantageously avoid causing dangers to a user operating a tool such as an angle grinder or circular saw whilst cutting a block.

In a preferred embodiment the lip extends along two edges of the plate to define a 90° internal corner (right angle). This is a second corner to the notch provided on an inner face of the lip. In this way an item to be cut can be positioned in the internal corner, is in contact with two sides and can be cut to set lengths by using different slots, as each slot is a different length from the internal corner.

Preferably the notch on the inner face of the lip into which an item is received is at 90°. The notch provides two sides of contact with an object to be cut. This enables the corner of an item to be located in the notch and cut, for example the corner of a block, brick, or tile, to be positioned in the notch over the associated slot so that an accurate cut is made. The notch helps to locate the item to be cut. Advantageously this enables a 45° cut to be made when there is a slot passing centrally through the notch.

It is appreciated that the notch on the inner face of the lip may be provided at different angles to achieve different cuts.

In preferred embodiments an upper surface of the planar plate has incremental markings to enable cutting of the material to pre-set lengths and widths.

In some embodiments an upper face of the plate has incremental markings to enable 30 cutting of the material to pre-set angles. The angle markings may be envisaged to help in scoring blocks, whereby aids, so as to allow a user to score a block at an angle to the lip that is not provided for by slots.

Preferably the guide has a plurality of slots arranged along the length of the guide. The slots pass through the lip and part of the plate.

Preferably the slots have parallel edges for guiding a cutting blade.

In some embodiments the slot may taper from an upper surface of the plate to a lower surface of the plate so that a blade is guided to a narrower region of the slot when passing downwards through and item to be cut.

The guide has two or more slots to provide two or more cutting or scoring locations. In some embodiments the guide has a central slot and one or more slot either side of the central slot. Preferably one or more slot is provided spaced apart from the central slot, for example providing side slots spaced apart along the lip and parallel to the central slot. In some embodiments the side slots may be at a different angle to the lip from the central slot.

The slots may be of different depths and thicknesses. For example, a first slot may be of a first width and a second slot may be of a second width. This may allow for different types of cutting blade to be used. Additionally or alternatively, a first slot may be of a first length and a second slot may be of a second length. This allows for a cutting blade to only cut to a certain depth, for example to accommodate different sized items.

Preferably at least one of the slots extends along the plate by a length that is greater than the height the lip extends from the top face. This allows for longer cuts to be made than would be possible with the smaller cutting slots.

In preferred embodiments the plate includes mounting holes that pass through the plate. The mounting holes are a form of securing means. In this way anchor such as a bolt, nail or screw may be passed the mounting hole and fixed so a subordinate surface in order to hold the guide in a fixed position during cutting. For example this may enable the guide to be secured onto scaffold boards.

In some embodiments the mounting holes may be adapted to receive U bolts and retaining nuts, so as to allow the cutting guide to be secured around scaffold ledgers.

In preferred embodiments a lower face of the plate includes supporting ribs to strengthen the guide whilst keeping it lightweight. The ribs may also be associated 35 with braces or other supports to improve the strength of the plate.

In some embodiments the plate may include reinforcing materials, for example metal bars passing through the plate. Advantageously the reinforcing materials may also serve to block a cutting blade, for example to prevent cutting beyond the depth of a slot which will improve safety.

In some embodiments the height of the lip that extends from the top face of the plate is substantially the same height as the thickness of the plate. In some embodiments the height of the lip is equal to the thickness of the plate and the barbs to create a deeper slot. Advantageously having a deeper slot may limit the blade coming in contact with the user during cutting through the block as the blade is more contained within the slot.

It is appreciated that the length of the slots may provide a guide to where to cut through a block rather than a cut guide as known in the art of mitre jigs. For example the slot may be dimensioned provide suitable space and clearance for the blade to cut through the brick/block without damaging the guide.

Additionally as the lip extends from the plate the saw blade of the tool is much less liable to come into contact with the lip, limiting dangers of damage to the lip, or kickback from contact during cutting which enhances safety.

Preferred embodiments of the invention will now be described by way of example only and with reference to the Figures in which:

### BRIEF DESCRIPTION OF FIGURES

FIG. 1A shows a top view of a first embodiment of the cutting guide;

FIG. 1B shows a cross section of the first embodiment of the cutting guide;

FIG. 10 shows a side profile of the first embodiment of the cutting guide;

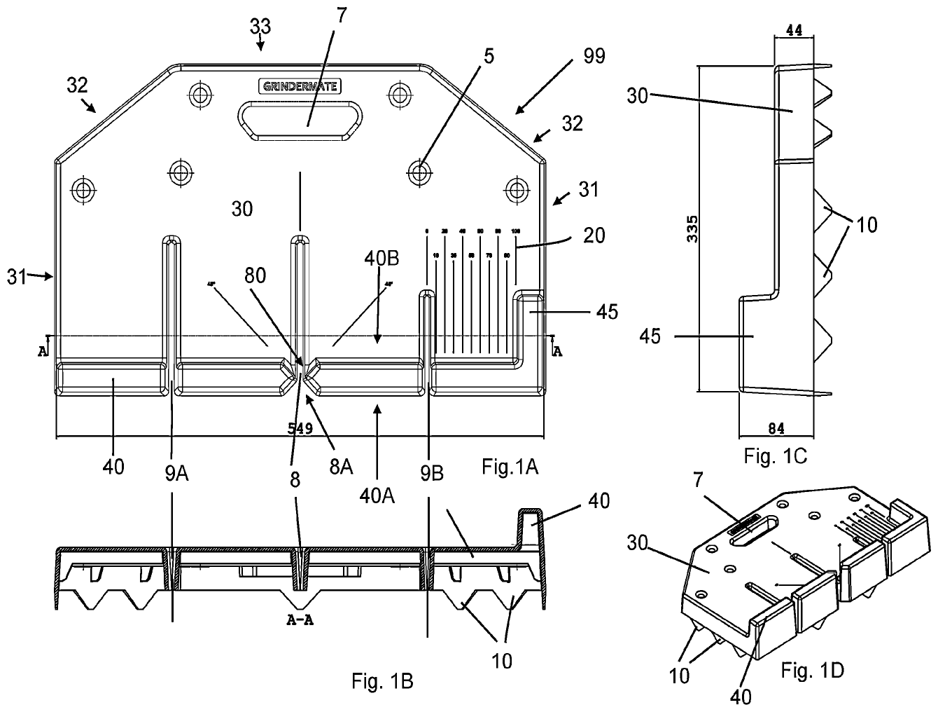

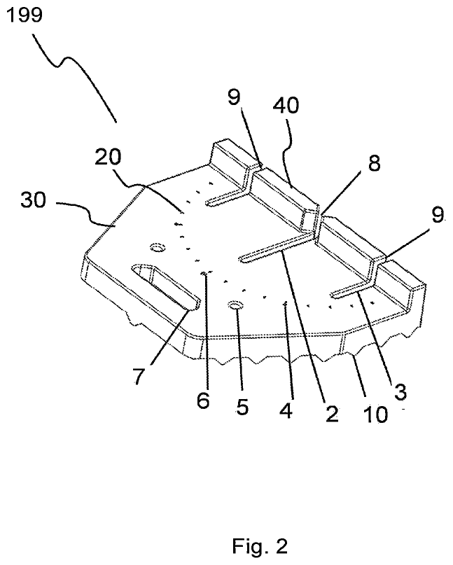

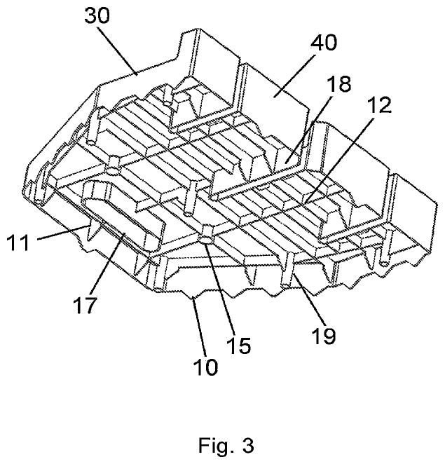

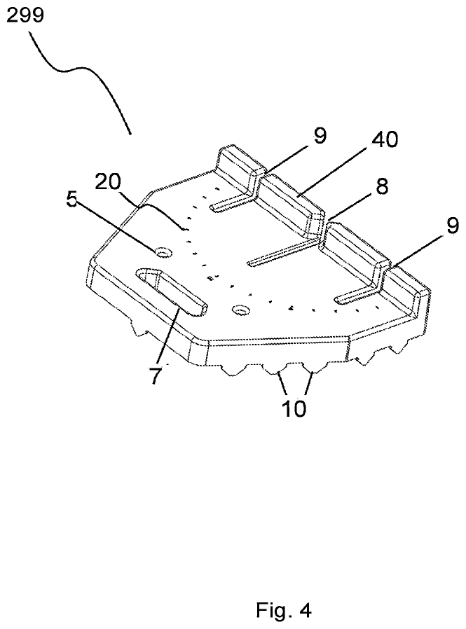

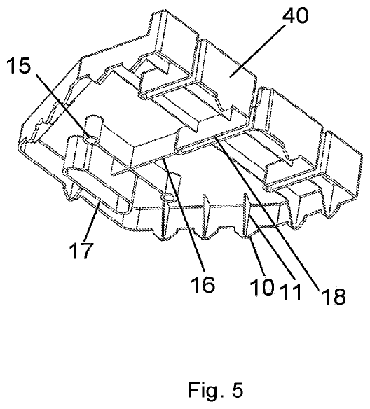

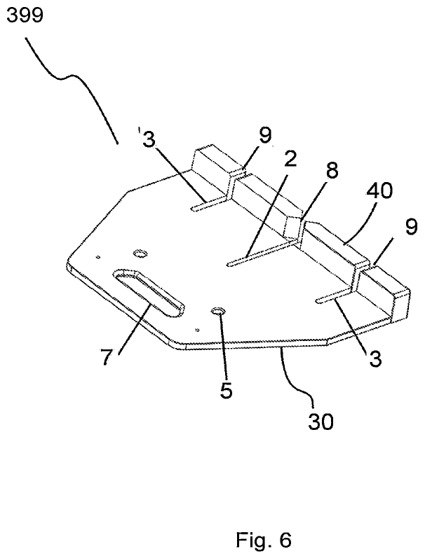

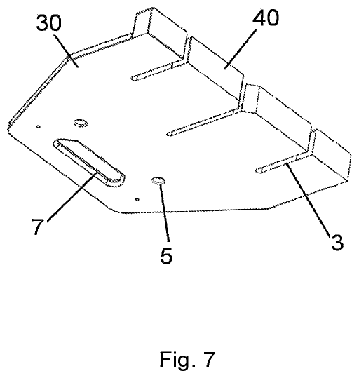

FIG. 1D shows an isometric view of the first embodiment of the cutting guide

FIG. 2 shows an isometric view of a second embodiment of the cutting guide;

FIG. 3 shows a reverse isometric view of the embodiment of the cutting guide;

FIG. 4 shows an isometric view of a third embodiment of the cutting guide;

FIG. 5 shows a reverse isometric view of the embodiment of the cutting guide shown in FIG. 4;

FIG. 6 shows an isometric view of a second embodiment of the cutting guide; and

FIG. 7 shows a reverse isometric view of the embodiment of the cutting guide shown in FIG. 6.

### DETAILED DESCRIPTION OF FIGS.

With reference to the embodiments shown in the figures there are shown four embodiments 99, 199, 299, 399 of the cutting guide.

Each guide has a planar plate 30 with a lip 40. The planar plate has six sides, having the shape of half an octagon. The main lip 40 is along the longest edge.

Two other edges 31 of the plate 30 extend perpendicular from the longest edge with the main lip 40, and two further sides 32 extend diagonally away from the perpendicular edges 31 to a short straight edge 33 that is parallel to the main lip 40 (see FIG. 1A).

In the first embodiment a second lip 45 extends part way along one of the perpendicular edges 31 (see FIG. 1A). The main lip 40 and second lip 45 join to define a 90° corner.

The lips 40, 45 extend orthogonally from the plate 30 creating an upstanding edge 30 against which items to be cut are positioned against.

One or more slots 8, 9 passes through the lip 40 and the plate 30. Slots are not shown passing through the second lip 45, however it is appreciated that slots may be provided on this edge.

An upper surface of the plate 30 has markings 20 for measurements associated with one or more slots 8, 9.

In the first, second and third embodiments, 99, 199, 299 the plate 30 has a lower face securing means 10 in the form of raised and lowered surface that defines barbs that are adapted to dig into the ground when placed on a soft surface such as grass or soil.

Preferably the cutting guides 99, 199, 299, 399 are formed from a single moulding made from robust synthetic plastics such as acrylonitrile butadiene styrene (ABS).

In the first, second and third embodiments 99, 199, 299 the height of the lip 40 that extends from the upper surface of the plate 30 is substantially the same as the thickness of the plate 30.

In the fourth embodiment shown in FIGS. 6 and 7, the lip 40 is more than the thickness of the plate 30.

In all embodiments shown, the slots extend through the lip 40 and through part of the plate 30. Each slot is longer than the height of the lip from the top face.

A handle 7 is provided by an elongate hole through the plate which is parallel to the lip 40. The handle 7 is provided adjacent to the upper shorter edge 33.

Two mounting holes 5 are provided through the plate 30. The mounting holes 5 provide 25 holes vertically through the plate 30, providing a means to engage a subordinate structure or surface of a subordinate structure, such as a bench or surface of a machine or to add clamps, clips etc.

The first embodiment 99 has 6 mounting holes that are arranged either side of the 30 handle 7. The second, third and fourth embodiments 199, 299, 399 each have two mounting holes 5.

The barbs 10 shown in the first, second and third embodiments 99, 199, 299 are arranged to extend downwards from outer edges of the plate. The barbs 10 are 35 substantially triangular portions that have a tip that engages with and digs into the ground in order to fix the guide in position.

The first embodiment 99 has two barbs 10 on the longest edge, three barbs on each perpendicular edge 31, two barbs on each diagonal edge 32 and one barb on the edge 33 parallel to the longest edge with the main lip 40.

The first embodiment 99 has two barbs 10 on the longest edge, three barbs on each perpendicular edge, two barbs on each diagonal edge and one barb on the edge parallel to the longest edge.

The second embodiment 199 has two barbs 10 on the longest edge, three barbs on each perpendicular edge, four barbs on each diagonal edge and one barb on the edge parallel to the longest edge. With reference to the second embodiment the embodiment comprises barbs with flattened points, which may be envisaged to be more secure on a hard subordinate surface.

The third embodiment 299 has two barbs 10 on the longest edge, two barbs on each perpendicular edge, three barbs on each diagonal edge and one barb on the edge parallel to the longest edge.

The fourth embodiment 399 has no barbs on the lower surface of the plate.

In all embodiments the main lip 40 has a central slot 8, and two side slots 9, dividing the longest edge into four sections. The sections to either side of the central slot 8 each have a single barb 10. The outer sections do not have a barb 10.

With reference to the first embodiment 99 (see FIG. 1A) slots 9A and 8 are of the same length and slot 9B is shorter. The shorter slot 9B has a plurality of measurements 20 that assist with positioning the item to be cut so that it can be cut to a desired length.

With reference to FIGS. 2 to 7 the slots 8, 9 extend along the plate 2, 3. The central slot 8 has a greater depth 2 than the side slots 9 that have a smaller depth 3.

On a lower surface of the first, second and third embodiments 99, 199, 299 are ribs 12 to strengthen the plate 30.

In the second embodiment (see FIG. 3) the ribs are connected to triangular braces 11. The braced ribs are provided adjacent to the slots 18 and to the barbs 10.

Ribs 12 connect to the mounting holes 15 and handle 17. Ribs 12 and/or triangular braces 12 are connected to cylindrical posts 19 that extend vertically.

The central slot 8 has side walls on an inner and outer face of the lip that are at 45° in relation to the slot. When viewed from above (see FIG. 1A) the lip walls are opposed triangular points facing each other to either side of the slot. These angled walls define a tapered entrance 8A on the outer face of the lip 40A and a notch 80 on an inner face of the lip 40B that enables angled cuts to be accomplished at the central slot.

In the second and third embodiments 199, 299 a semicircle of markings 20 is arranged to extend around the slots 8, 9 from the lip 40, with incremental markings, including at 50° s and 90° s degrees to the lip.

With reference to the fourth embodiment the plate 30 shown in FIGS. 6 and 7 comprises a thin solid plate 30, which is better suited to placement on a flat subordinate surface such as a work bench. The mounting holes 5 may be used to secure the embodiment flat onto a subordinate surface such as a wooden board.

The invention has been described by way of examples only and it will be appreciated that variation may be made to the above-mentioned embodiments without departing from the scope of the invention as defined by the claims.

1. A cutting guide comprising: a substantially planar plate with a lip arranged to extend orthogonally from the plate along at least one edge of the plate; a plurality of slots is formed in the plate and extend through the lip for guiding a cutting blade; wherein an entrance to at least one of the slots on an outer face of the lip tapers to guide the cutting blade into the slot; and wherein a portion of an inner face of the lip is shaped to define a notch in which material to be cut is positioned.

2. The cutting guide according to claim 1 wherein the lip extends along two edges of the plate to define a 90° internal corner.

3. The cutting guide according to claim 1 wherein the notch on an inner face of the lip is 90° and the slot is arranged centrally to enable a 45° cut to be made.

4. The cutting guide according to claim 1 wherein an upper face of the plate has incremental markings to enable cutting of the material to pre-set lengths.

5. The cutting guide according to claim 1 wherein an upper face of the plate has incremental markings to enable cutting of the material to pre-set angles.

6. The cutting guide according to claim 1 wherein a first slot is of a first width and a second slot is of a second width.

7. The cutting guide according to claim 1 wherein a first slot is of a first length and a second slot is of a second length.

8. The cutting guide according to claim 1 including a securing means to secure the guide to a surface.

9. The cutting guide according to claim 8 wherein the securing means comprises a plurality of barbs extending from the lower face.

10. The cutting guide according to claim 8 wherein the plate includes securing holes that pass through the plate.

11. The cutting guide according to claim 1 wherein a lower face of the plate includes supporting ribs.

12. The cutting guide according to claim 1 wherein the height of the lip that extends from the top face of the plate is substantially the same height as the thickness of the plate.

13. The cutting guide according to claim 1 wherein at least one of the slots extends along the top face by a length that is greater than the height the lip extends from the top face.

14. A cutting tool includes the cutting guide according to claim 1 includes a handle.

15. (canceled)

16. The cutting tool according to claim 15 has six sides.
